(19) United States
(12) Patent Application Publication
(10) Pub. No.: US 2024/0059219 A1
(43) Pub. Date: Feb. 22, 2024

(54) OBSERVATION APPARATUS AND MOTOR VEHICLE WITH THE OBSERVATION APPARATUS

(71) Applicant: Volswagen Aktiengesellschaft, Wolfsburg (DE)

(72) Inventors: Steffen DOEHLERT, Magdeburg (DE); Uwe LUEBBEN, Ostercappeln (DE)

(73) Assignee: Volswagen Aktiengesellschaft, Wolfsburg (DE)

(21) Appl. No.: 18/234,694

(22) Filed: Aug. 16, 2023

(30) Foreign Application Priority Data
Aug. 16, 2022 (DE) 10 2022 120 706.4

(51) Int. Cl. B60R 1/076

(52) U.S. Cl. CPC B60R 1/076; H04N 23/54

(57) ABSTRACT

An observation apparatus for a motor vehicle for observing the rear traffic events, comprising a base member with a base member body for fastening to a bodywork or an add-on part of the motor vehicle, as well as comprising a head member which is arranged hingedly at the base member with a head member body and an observation member arranged therein or thereon. The base member body and the head member body are adjacent to each other at at least one gap and the head member body adjacent to the gap comprises at least one recessed region such that a step is formed between the base member body and the head member body by the recessed region. Furthermore, a motor vehicle is provided that is equipped with an observation apparatus.

This nonprovisional application claims priority under 35 U.S.C. § 119(a) to German Patent Application No. 10 2022 120 706.4, which was filed in Germany on Aug. 16, 2022, and which is herein incorporated by reference.

### BACKGROUND OF THE INVENTION

### Field of the Invention

The present invention relates to an observation apparatus and a motor vehicle equipped with the observation apparatus.

### Description of the Background Art

For participation in road traffic, it is indispensable and legally necessary to be able to monitor or observe events and traffic situations even behind a moving motor vehicle. For this purpose, rear-view mirrors have been used for a long time, which allow observation of rear traffic events by simple reflection. Exterior mirrors extend outward from the bodywork or a body attachment, such as a door of a motor vehicle. Here, the exterior mirrors are exposed to the airflow.

In order to reduce the risk of damage and to take up less space, exterior mirrors are often designed to be foldable so that they can be folded in from a position relatively far away from the body, so that the motor vehicle equipped with the exterior mirror comprises a smaller width overall. This folding or pivoting capability of the exterior mirror requires a joint in the region of the connection between the fastening to the bodywork or bodywork member and the mirror face, as well as a gap or joint in which a relative movement of the mirror face with respect to the fastening region can be carried out. A disadvantage of this, however, is that air flowing towards the exterior mirror can strike edges or even preceding members in the gap area, causing acoustic emissions. In other words, acoustic conspicuities can occur in the region of the pivot joint.

Various designs of exterior mirrors are known from the prior art. For example, U.S. Pat. No. 9,963,073 discloses a frameless exterior mirror which comprises a step jump at the transition between the casing of a head member held by means of a foot member and the mirror support. The step serves to drain off rainwater.

DE 10 2011 000 740 B4, which corresponds to US 2012/0206827 and which is herein incorporated by reference, discloses a drop gutter in the casing of an exterior mirror, wherein the drop gutter comprises walls stepped with respect to depth, so that on the one hand rainwater can be drained off and on the other hand a tear-off edge is created to reduce flow noise.

DE102008013605A1 shows a step in the casing of a mirror in a plane essentially parallel to a mirror face.

### SUMMARY OF THE INVENTION

It is therefore an object of the present invention to provide an observation apparatus for a motor vehicle for observing the rear traffic situation, as well as a motor vehicle equipped therewith, which agrees on a simple, robust as well as inexpensive embodiment with a design which, when exposed to air during driving of the motor vehicle, causes reduced noise emissions.

A first aspect of the invention is an observation apparatus for a motor vehicle for observing the rear traffic situation, which comprises a base member with a base member body for fastening to a bodywork or an add-on part of the motor vehicle, as well as a head member hingedly arranged on the base member with a head member body and an observation member arranged therein or thereon. The base member body and the head member body are adjacent to each other at at least one gap. The base member body comprises at least one recessed region adjacent to the gap, such that a step is formed between the base member body and the head member body by the recessed region. As a result, the air flow is disturbed and detaches from the face. Respectively, air flowing toward the observation apparatus is prevented from hitting an edge of the base member body when flowing along the base member body toward the head member body when flowing across the gap and causing undesirable noise to be generated there. In other words, the recessed region is arranged where air flowing toward the observation apparatus flows along the observation apparatus when a motor vehicle equipped with the observation apparatus moves forward, so that it first flows along the base member body and then flows along the head member body.

A lowering of the connecting faces of the mirror foot in the region of the hinge joint seal leads to a step jump. No acoustic abnormalities occur.

If the base member body and the head member body together form a connecting bar, such a connecting bar, in which one or more gaps are present between the base member body and the head member body, can extend away from the bodywork or an add-on part thereof. In this regard, such a connecting bar may also be configured such that a component of its longitudinal extension direction is parallel to the direction of travel of the motor vehicle equipped with the observation apparatus. In this orientation, when the motor vehicle equipped with the observation apparatus travels forward, the air flows along the observation apparatus in a respective manner such that it first flows along the base member body and then flows along the head member body via the gap.

The base member body and the head member body may be adjacent to each other at one gap or at multiple gaps, depending on the structural embodiment of the connecting region between the base member body and the head member body.

The base member body may serve for immediate or also for indirect attachment to a body or an add-on part of the motor vehicle.

The step may be formed between a face of the base member body and a face of the head member body, respectively, which together form a guide face having an extending direction of which at least one component extends along an incident direction of an air flowing toward the observation apparatus during forward travel of a motor vehicle equipped with the observation apparatus. The guide face is thus composed of a face of the base member body and a face of the head member body, which are separated from each other by a gap. Respectively, the step is not necessarily realized at a face whose plane is aligned perpendicularly to the incident direction. In other words, at a gap or gap portion which is arranged at the front side of the observation apparatus and where, when the motor vehicle equipped with the observation apparatus moves forward, air does not flow first along the base member body and then along the head member body via the gap, but meets the base member body and the head member body head-on, it is not mandatory to also form the step here.

The observation apparatus may be an external mirror, so that the observation member is a mirror face or a mirror face system. Further, the observation apparatus can be a camera, so that the observation member is a camera lens or camera lens system.

The base member body and/or head member body may be designed by a casing, respectively. A respective casing may be formed to be hollow.

Furthermore, the observation apparatus may be configured such that the observation apparatus comprises a hinge joint which hingedly connects the base member body and the head member body to each other, wherein, when the observation apparatus is mounted on a bodywork or an add-on part of the motor vehicle, the rotation axis of the hinge joint extends vertically. This refers to an embodiment in which the transition between the base member body and the head member body is formed by a connecting bar, and the head member body can be rotated in a horizontal plane. Here, the gap runs in several segments extending at an angle to each other, or individual gaps exist between adjacent faces of the base member body and the head member body, which extend at an angle to each other. However, an embodiment in which the rotation axis oblique is also not excluded from the invention. In this alternative embodiment, a gap between the base member body and the head member body also runs obliquely and circumferentially, respectively.

The height of the step between the base member body and the head member body may thereby be at least 1 mm. This step dimension thereby applies at least at a distance of 10 mm around the gap delimiting the retracted face.

The step between the base member body and the head member body can be realized by a face of the base member body and a face of the head member body, wherein the face of the base member body and the face of the head member body can be parallel to each other. The parallelism is to exist over a distance to the gap of at least 50 mm.

The step between the base member body and the head member body can be realized by a face of the base member body and a face of the head member body, wherein the face of the base member body and the face of the head member body can extend at an acute angle to each other. This means that neighboring faces on the base member body and the head member body, which are separated from each other only by a gap and form a step, enclose an acute angle with their outer sides.

The acute angle can be at most 20°. The acute angle can be intended to exist over a distance from the gap of at least 50 mm.

Another aspect of the present invention is a motor vehicle which comprises at least one observation apparatus described. The motor vehicle may be an at least partially electrically drivable motor vehicle and/or an at least partially autonomously drivable motor vehicle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view from below of an observation apparatus in the form of an exterior mirror,

FIG. 2 shows a sectional view of the observation apparatus along the sectional path A-A from FIG. 1, and

FIG. 3 shows an enlarged view of the partial area B from FIG. 2.

### DETAILED DESCRIPTION

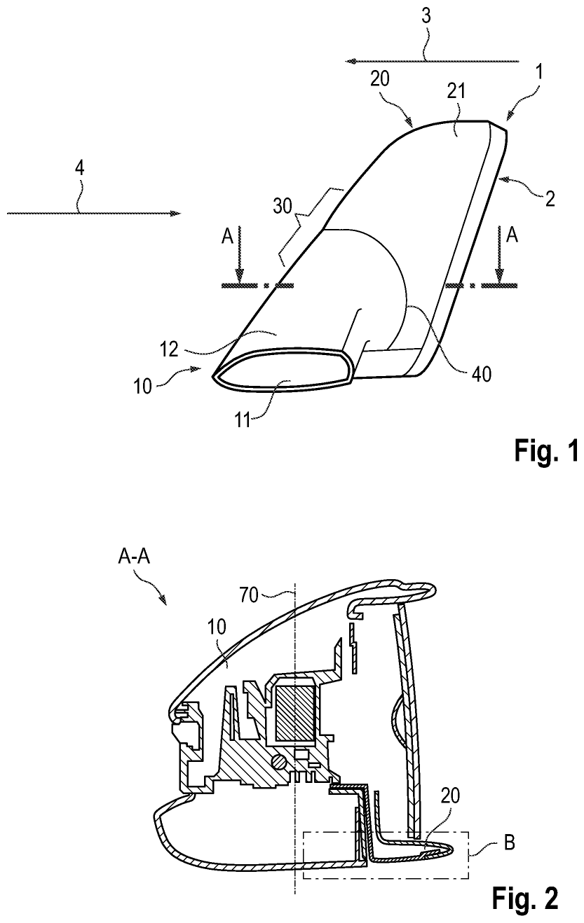

FIG. 1 shows an observation apparatus 1 in perspective view from below. The observation apparatus 1 shown here is an exterior mirror with a base member 10 for fastening to a bodywork or also to an add-on part of a motor vehicle on a fastening side 11 of the base member 10.

The observation apparatus 1 further comprises a head member 20, which is hingedly and lockably connected to the base member 10 by means of a hinge joint. Thereby, the head member 20 is arranged on the side of the base member 10 facing away from the fastening side 11 of the base member 10. Furthermore, the observation apparatus illustrated here comprises an observation member 2 in the form of a mirror face.

The observation apparatus 1 could also comprise a camera instead of a mirror face as observation member 2.

The base member 10 comprises a base member body 12 formed by a casing, and the head member 20 comprises a head member body 21 also member by a casing, wherein the base member body 12 the head member body 21 are adjacent to each other at a gap 40. This gap 40 extends through a relatively short connecting bar 30 designed through both casings of the base member body 12 as well as the head member body 21.

As can be seen from FIG. 2, the hinge joint may realize a rotation axis 70 which extends essentially vertically, so that consequently a rotating movement of the head member body 21 can be executed in an essentially horizontal plane around the foot member 10. Respectively, the gap 40 shown in FIG. 1 is also arcuate.

FIG. 1 further shows that when a motor vehicle equipped with the observation apparatus 1 moves forward along the direction of travel 3, there is an incident flow of air along the incident flow direction 4 to the observation apparatus 1.

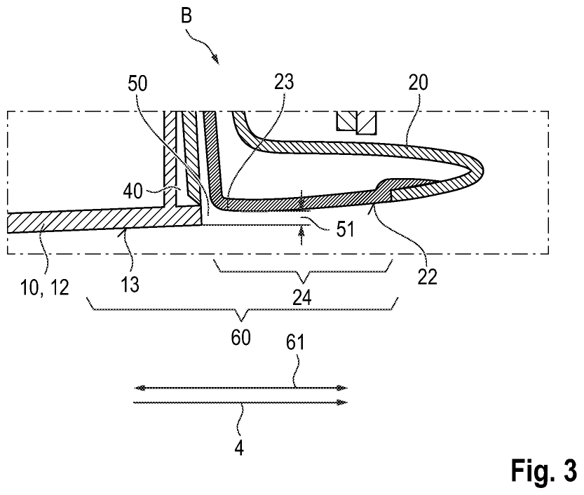

FIG. 3 shows that a recessed region 24 is designed on the base member body 21 adjacent to the gap 40, resulting in a step 50 being realized between a face of the base member body 13 and a face of the base member body 22, which together form a guide face 60 on the connecting bar 30.

The face of the base member body 13 and the face of the head member body 22 are separated from each other only by the gap 40.

An extension direction 61 of the guide face 60, which comprises the face of the base member body 13 and the face of the head member body 22, thereby extends along the incident direction 4.

Due to the recessed region 40 in the base member body 21, which results in an offset of the face of the base member body 22 with respect to the face of the base member body 13, an edge 23 of the base member body 21 is offset inwardly. In this way, the step 50 is implemented with a height 51 so that air flowing along the direction of incident 4 at the face 13 of the base member body—after it flowed over the gap 40—does not hit this edge 23 of the head member body 21. This prevents unwanted noise emissions from occurring.

What is claimed is:

1. An observation apparatus for a motor vehicle for observing rear traffic events, the observation apparatus comprising:
a base member with a base member body to fasten the base member to a bodywork or an add-on part of the motor vehicle; and
a head member which is arranged hingedly at the base member with a head member body and an observation member arranged therein or thereon,
wherein the base member body and the head member body are adjacent to each other at at least one gap, and
wherein the head member body adjacent to the gap comprises at least one recessed region such that a step is formed between the base member body and the head member body by the recessed region.

2. The observation apparatus according to claim 1, wherein the step is formed between a face of the base member body and a face of the head member body, respectively, which together form a guide face having an expansion direction, wherein at least a component of which extends along an incident flow direction of an air flowing incident to the observation apparatus during forward travel of the motor vehicle equipped with the observation apparatus.

3. The observation apparatus according to claim 1, wherein the observation apparatus is an exterior mirror such that the observation member is a mirror face or mirror face system, or wherein the observation apparatus is a camera such that the observation member is a camera lens or camera lens system.

4. The observation apparatus according to claim 1, wherein the base member body and/or head member body is formed by a casing.

5. The observation apparatus according to claim 1, wherein the observation apparatus comprises a hinge joint hingedly connecting the base member body and the head member body to one another, and wherein, when the observation apparatus is mounted on a bodywork or an add-on part of the motor vehicle, the axis of rotation of the hinge joint extends substantially vertically.

6. The observation apparatus according to claim 1, wherein a height of the step between the base member body and the head member body is at least 1 mm.

7. The observation apparatus according to claim 1, wherein the step between the base member body and the head member body is realized by a face of the base member body and a face of the head member body, and wherein the face of the base member body and the face of the head member body are substantially parallel to each other.

8. The observation apparatus according to claim 1, wherein the step between the base member body and the head member body is realized by a face of the base member body and a face of the head member body, and wherein the face of the base member body and the face of the head member body are at an acute angle to each other.

9. The observation apparatus according to claim 8, wherein the acute angle is at most 20°.

10. A motor vehicle comprising at least one observation apparatus according to claim 1.
